(19) United States
(12) Patent Application Publication
(10) Pub. No.: US 2013/0300243 A1
(43) Pub. Date: Nov. 14, 2013

(54) HIGH POWER DENSITY PERMANENT MAGNET MACHINE

(71) Applicants: Jacek F. Gieras, Glastonbury, CT (US); Gregory I. Rozman, Rockford, IL (US); Lubomir A. Ribarov, West Hartford, CT (US)

(72) Inventors: Jacek F. Gieras, Glastonbury, CT (US); Gregory I. Rozman, Rockford, IL (US); Lubomir A. Ribarov, West Hartford, CT (US)

(21) Appl. No.: 13/469,260

(22) Filed: May 11, 2012

(51) Int. Cl. H02K 1/08

(52) U.S. Cl. 310/156.43

(57) ABSTRACT

A permanent magnet rotary machine includes a rotor and a plurality of circumferentially spaced permanent magnets spaced circumferentially about a rotational axis of the rotor. A stator is positioned adjacent the rotor, and includes a plurality of circumferentially spaced U-shaped cores. The U-shaped cores are provided with a separate coil. The cores are arranged such that at least three phases of electric power are created by three sets of the cores.

### BACKGROUND OF THE INVENTION

This application relates to a permanent magnet machine, wherein the power density is increased due to an arrangement of the components.

Various types of machines are known, which may operate as a generator or a motor, depending on an input into the machine. As an example, a rotor which carries permanent magnets as part of the machine may be driven to rotate by a source of rotation, such as an engine. The permanent magnets rotate in proximity to a stator armature and generate electrical power. On the other hand, if electrical power is provided to the stator armature, it can drive the permanent magnet rotor to rotate as a motor.

Various types of machines are known, however, it would be desirable to increase the power density of the machine.

### SUMMARY OF THE INVENTION

A permanent magnet rotary machine includes a rotor and a plurality of circumferentially spaced permanent magnets spaced circumferentially about a rotational axis of the rotor. A stator is positioned adjacent the rotor, and includes a plurality of circumferentially spaced U-shaped cores. The U-shaped cores are provided with a separate coil. The cores are arranged such that at least three phases of electric power are created by three sets of the cores.

These and other features of this application will be best understood from the following specification and drawings, the following of which is a brief description.

### BRIEF DESCRIPTION OF THE DRAWINGS

FIG. 1 is a cross-sectional view through a machine according to this application.

FIG. 2 is a cross-sectional view taken approximately 90° to FIG. 1.

FIG. 3 shows an alternative embodiment.

FIG. 4 is a cross-sectional along line 4-4 of FIG. 3.

### DETAILED DESCRIPTION

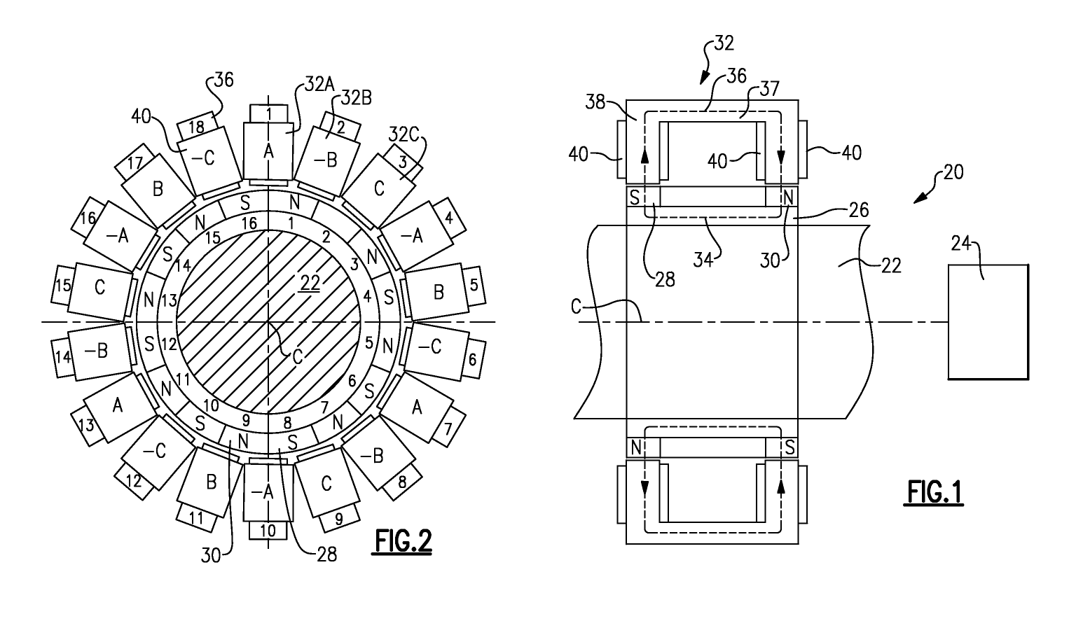

A machine 20 illustrated in FIG. 1, has a shaft 22 which may be connected to drive a use at 24, if the machine 20 is utilized as a motor. Alternatively, the use 24 can be a source of rotation such as a gas turbine engine, and the machine may be utilized as a generator.

A ferromagnetic yoke 26 rotates with the shaft 22. Permanent magnets 28 and 30 are positioned on the yoke 26.

A stator 32 is positioned radially outward of the rotor, and has a plurality of U-shaped cores 36. The cores 36 can be seen to have a back web 37 connecting two legs 38 to form the U-shape. The legs 38 extend radially inwardly from the web 37. In this embodiment, each of the legs 38 are provided with separate coils 40. The provided flux path is shown as 34.

Generally, in the prior art, the coils were provided within slots and the stators have been relatively large compared to this embodiment. Stator coils being placed on separate cores, and shown in FIG. 2, provide a high winding packing factor. As an example, the winding packing factor may be greater than or equal to 0.8. This provides a large contact surface for cooling, and thus current density can be higher than conventional stators.

The disclosed machine has a very high power density compared to the prior art. Power density can be defined as an output power-to-mass ratio, or an output power-to-volume ratio. The present machine has a relatively small packaging envelope and still provides very high power output, thus resulting in a high power density.

The rotor permanent magnets 28 and 30 may be glued to the yoke 26 utilizing appropriate adhesives. Alternatively, a Halbach array may attach the permanent magnets instead, with the yoke 26 being formed of a non-ferromagnetic material.

Rare-earth permanent magnets may be utilized to obtain a high air gap magnetic flux density.

As shown in FIG. 2, the U-shaped cores are circumferentially arranged about a central axis C which is the rotational axis of the shaft 22. The cores are arranged so as to provide three phases of electrical power to drive the shaft 22, or will create three phases should the machine 22 operate as a generator. As can be seen in FIG. 2, the coils are provided with the letters +/−A, B, and C to show an example location for the three sets of cores and coils to provide the three phases of power. As an example, FIG. 2 illustrates cores 32A, 32B, and 32C as part of the three sets.

The number of permanent magnets is shown to be 16, while the number of stator cores is shown to be 18. Notably, the cross-section of FIG. 2 is through only one end of the FIG. 1 embodiment.

Preferably the following relationship is utilized to determine the number of rotor permanent magnets and stator cores:

$$\frac{{N}_{c}}{GCD ( {N}_{c} , {n}_{PM} )} = k m \qquad Equation ( 1 )$$

In the above equation N_{c} is the number of stator cores, n_{PM} is the number of rotor permanent magnets in one parallel row, GCD is the greatest common divisor of N_{c} and n_{PM}, k=1, 2, 3, . . . is an integer, and m is the number of stator phases.

For example, for the machine shown in FIG. 1, m=3, N_{c}=18 n_{PM}=16, GCD(18,16)=2, and k=3. The machine meets the condition given by equation (1).

The machine as described above can operate as a synchronous machine or a direct current brushless machine.

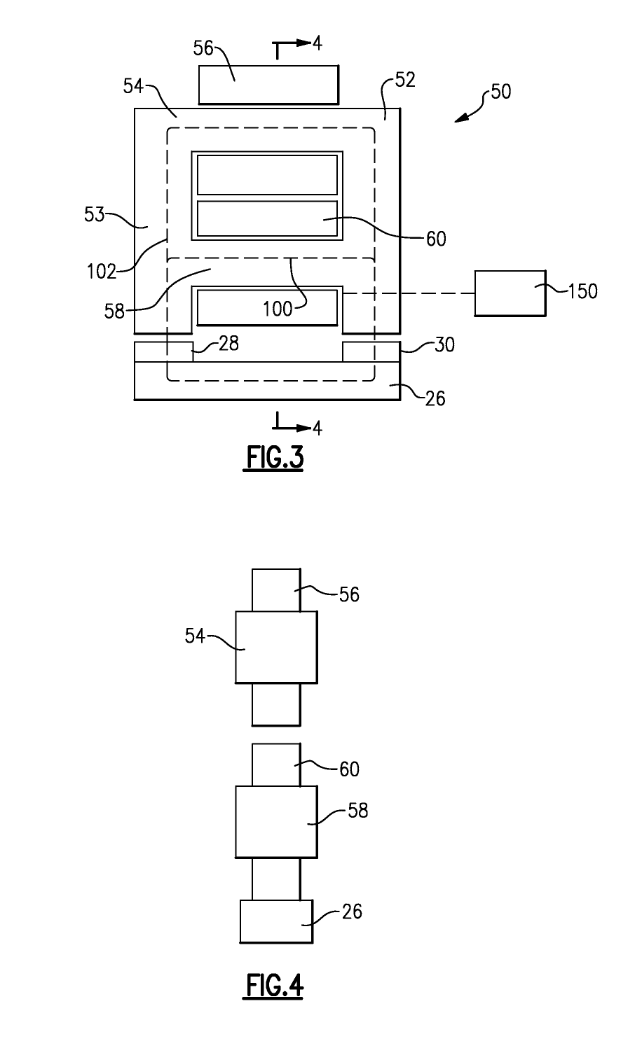

FIG. 3 shows another embodiment 50 having a control coil 60 incorporated around a flux diverter 58. The magnets 28 and 30 are still associated with the yoke 26. However, in this embodiment, the U-shaped core 52 is provided with the flux diverter 58 extending across its axial length, and the coil 56 is provided around the web portion 54, rather than the legs 53 of the core 52. This embodiment also provides high power density.

As known, the control coil 60 can allow regulation of the provided magnetic flux. The control flux is shown at 100, and the overall flux at 102.

A control 150 can supply a control current to the control coil 60. When a current is supplied, magnetic flux diverter 58 is saturated by the control current The higher the control current, the higher the saturation of the flux diverter 58, and the higher the magnetic flux 102 that will be provided by the overall core.

When the control current is moved to zero, almost the total magnetic flux produced by the permanent magnets passes through the flux diverter 58 and a very small flux will be linked with the armature winding. Thus, at zero control current, an output voltage of an associated generator will take a minimum value, and an electric motor will provide minimum torque.

The control 150 controls the current supplied to control coil 60 to achieve desired conditions for the motor or generator. The function of the control coil is generally as known in the art, however, its use in such a unique machine is also novel.

FIG. 4 is a cross-sectional view of lines 4-4 of FIG. 3, and shows that the coils 56 and 60 are separate.

As can be appreciated, appropriate connections between all of the cores associated with each of the three phases of power A, B and C would be included, as known.

The combination of U-shaped cores each carrying their own coil, and the cores being arranged circumferentially about a rotational axis, and connected in at least three sets to provide at least three phases of power, is unique, and results in the compact packaging benefits as mentioned above.

While the stator is shown surrounding the rotor, the stator could also be positioned within the rotor, with the rotor rotating outside of the stator.

Although an embodiment of this invention has been disclosed, a worker of ordinary skill in this art would recognize that certain modifications would come within the scope of this invention. For that reason, the following claims should be studied to determine the true scope and content of this invention.

1. A permanent magnet rotary machine comprising:
a rotor including a plurality of permanent magnets spaced circumferentially about a rotational axis of the rotor; and
a stator positioned adjacent said rotor, said stator including a plurality of circumferentially spaced U-shaped cores, with each of said U-shaped cores provided with a separate coil, and said cores being arranged such that at least three phases of electric power are created by at least three sets of said cores.

2. The machine as set forth in claim 1, wherein said stator is positioned radially outwardly of said rotor.

3. The machine as set forth in claim 2, wherein each said U-shaped core includes coils on each of two legs extending radially toward said rotor from a central web of said core positioned radially outwardly of said two legs.

4. The machine as set forth in claim 2, wherein said U-shaped core includes a coil positioned about a web connecting two legs of said core, with said web positioned radially outward of said two legs.

5. The machine as set forth in claim 3, wherein a flux diverter is positioned radially inwardly of said web and connects said two legs, and a control coil is positioned about said flux diverter.

6. The machine as set forth in claim 5, wherein a control current to said control coil is controlled to change an overall flux provided between said rotor and said stator.

7. The machine as set forth in claim 1, wherein a flux diverter is positioned radially inwardly of a web that connects two legs to form said U-shaped cores, and a control coil is positioned about said flux diverter.

8. The machine as set forth in claim 7, wherein a control current to said control coil is controlled to change an overall flux provided between said rotor and said stator.

9. The machine as set forth in claim 1, wherein the number of permanent magnets on the rotor and the number of U-shaped stator cores is defined by the following relationship:
$$\frac{{N}_{c}}{GCD ( {N}_{c} , {n}_{PM} )} = k m$$
and
where N_{c} is the number of stator cores, n_{PM} is the number of rotor permanent magnets in one parallel row, GCD is the greatest common divisor of N_{c} and n_{PM}, k=1, 2 , 3, . . . is an integer, and m is the number of stator phases.

10. A permanent magnet rotary machine comprising:
a rotor including a plurality of permanent magnets spaced circumferentially about a rotational axis of the rotor; and
a stator positioned adjacent said rotor, said stator including a plurality of circumferentially spaced U-shaped cores, with each of said U-shaped cores provided with a separate coil, and said cores being arranged such that at least three phases of electric power are created by at least three sets of said cores;
said stator positioned radially outwardly of said rotor; and
the number of permanent magnets on the rotor and the number of U-shaped stator cores being defined by the following relationship:
$$\frac{{N}_{c}}{GCD ( {N}_{c} , {n}_{PM} )} = k m ;$$
and
where N_{c} is the number of stator cores, n_{PM} is the number of rotor permanent magnets in one parallel row, GCD is the greatest common divisor of N_{c} and N_{PM}, k=1, 2, 3, . . . is an integer, and m is the number of stator phases.

11. The machine as set forth in claim 10, wherein each said U-shaped core includes coils on each of two legs extending radially toward said rotor from a central web of said core positioned radially outwardly of said two legs.

12. The machine as set forth in claim 10, wherein said U-shaped core includes a coil positioned about a web connecting two legs of said core, with said web positioned radially outward of said two legs.

13. The machine as set forth in claim 12, wherein a flux diverter is positioned radially inwardly of said web and connects said two legs, and a control coil is positioned about said flux diverter.

14. The machine as set forth in claim 13, wherein a control current to said control coil is controlled to change an overall flux provided between said rotor and said stator.

15. The machine as set forth in claim 10, wherein a flux diverter is positioned radially inwardly of a web that connects two legs to form said U-shaped cores, and a control coil is positioned about said flux diverter.

16. The machine as set forth in claim 15, wherein a control current to said control coil is controlled to change an overall flux provided between said rotor and said stator.
